(19) United States
(12) Patent Application Publication
(10) Pub. No.: US 2008/0241473 A1
(43) Pub. Date: Oct. 2, 2008

(54) METALLIC FINE PARTICLE DISPERSED FILM, AND PROCESS FOR PRODUCING THE SAME

(75) Inventors: Miho MARUYAMA, Yokohama-shi (JP); Kenji Todori, Yokohama-shi (JP); Tsukasa Tada, Hachioji-shi (JP); Reiko Yoshimura, Kawasaki-shi (JP); Ko Yamada, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/026,956

(22) Filed: Feb. 6, 2008

(30) Foreign Application Priority Data
Mar. 26, 2007 (JP) 2007-078838

(51) Int. Cl. B05D 3/10; B05D 5/00; B32B 5/16; B32B 33/00

(52) U.S. Cl. 428/148; 427/344

(57) ABSTRACT

The present invention is related to a process for producing a metallic fine particle dispersed film which includes metallic fine particles dispersed densely within a silicon oxide layer without aggregation. The process includes hydrolyzing and polycondensing an organosilane to form a silicon oxide layer with hydroxyl and/or alkoxide groups remaining unremoved on its side chains, bringing the silicon oxide layer into contact with an aqueous acidic tin chloride solution, and then bringing the silicon oxide layer into contact with an aqueous metal chelate solution to disperse metallic fine particles in the silicon oxide layer.

### CROSS-REFERENCE TO RELATED APPLICATIONS

This application is based upon and claims the benefit of priority from the prior Japanese Patent Application No. 2007-78838, filed on Mar. 26, 2007; the entire contents of which are incorporated herein by reference.

### BACKGROUND OF THE INVENTION

The present invention relates to a process for producing a film in which metallic fine particles have been dispersed densely.

The metallic fine particle dispersed film produced by the process according to the present invention is advantageously suitable for use in optical devices such as three-dimensional nonlinear optical films and plasmon waveguides.

With the advance of nanomaterial technology, studies on various nanoparticle dispersed inorganic matrix composite materials have been made, and the nanoparticle dispersed inorganic matrix composite materials are expected to be utilized in a broad range of application fields from semiconductors to medical equipment.

Up to now, various methods for producing metallic nanoparticles have been studied. One of them is a method for depositing fine particles of palladium (Pd) or the like, for catalization treatment in electroless plating, onto the surface of a nonelectroconductive material, which method has been studied from a long time ago. This method is one for use in the formation of a plating film of a metal such as copper (Cu) or nickel (Ni) on the surface of the nonelectroconductive material and is generally carried out through the following steps.
(1) Cleaning step
(2) Surface modifying step
(3) Catalyst imparting step
(including, for example, sensitizing-activation treatment, catalyst-accelerator treatment, and electroless plating.)

In the above technique, the application of steps (1) to (3) can realize the deposition of fine particles of palladium (Pd), silver (Ag) or the like onto the surface of an inorganic material such as silica. In this connection, however, it should be noted that surface active agents (for example, sodium dodecylbenzenesulfonate) for stabilizing silver colloidal particles and reducing agents (for example, sodium borohydride) for preparing silver colloid should be added, for example, to an activator liquid containing silver ions, leading to problems of reagent costs, the necessity of ensuring safety, and the stay of a part of these chemicals as impurities. Further, there is an additional problem that the above method utilizes a deposition phenomenon of particles on the surface of a substrate and, thus, disadvantageously, the silver particles can be present only in a planar form, that is, a two-dimensional form on the surface of the substrate.

On the other hand, studies on a nanoparticle production technique using a combination of an electroless plating technique with colloid chemistry have also been made (Y. Kobayashi, et al., Chem. Mater., 13 (2001) 1630). Specifically, for example, in this technique, SiO₂ monodisperse colloidal particles having a diameter of 200 to 300 nm are previously prepared in a water solvent by a synthetic method called the so-called Stoeber method according to a sol-gel process. OH groups remaining unreacted are present on the surface of the particles. SnCl₂, together with an acid, is added to the colloidal solution for a reaction with the OH groups present on the surface of SiO₂, whereby Sn²⁺ is chemisorbed on the surface of the SiO₂ monodisperse spheres. This step corresponds to the sensitizing treatment in the above step (3). The silver ions in the solution are reduced with the chemisorbed Sn²⁺. This step corresponds to the activation treatment in the above step (3). According to this step, when the number density is low, silver nanoparticles having a size of a few nanometers can be prepared on the surface of SiO₂ spheres (Y. Kobayashi, et al., Chem. Mater., 13 (2001) 1630).

Further, since all the reactions are carried out in a colloidal solution, there is no need to provide the above step (1) (cleaning step). Further, since originally present OH groups remaining unreacted are applied, the above step (2) (surface modifying step) is also not necessary. Further, neither the reducing agent for preparing the silver colloid nor the surface active agent for stabilization is required. Accordingly, unlike the case where a conventional electroless plating step is applied, silver nanoparticles can be prepared by a simple process.

In the method using the sol-gel process, however, the reaction proceeds on the surface of SiO₂ spheres, and, thus, disadvantageously, silver nanoparticles can be formed only on the surface thereof. Therefore, when the silver deposition amount is increased, aggregation among the silver nanoparticles is significant, and, thus, that the diameter of the silver particles reaches a few tens of nanometer or more, cannot be inhibited. That is, in these conventional methods, it is difficult to densely disperse silver nanoparticles having a size of a few nanometers. Further, a silver nanoparticle dispersed structure can be formed only in a two-dimensional form on the surface of SiO₂.

Further, JP-A 2006-332046 (KOKAI) discloses a technique regarding a display element comprising a light absorbing layer formed of metallic nanoparticles contained in a matrix material, wherein the content of the metallic nanoparticles in the light absorbing layer is about 5 to 50% by volume. What is described on production methods for the display element material is only a method which comprises previously preparing a dispersion liquid of a metal and a polymer and then coating the dispersion liquid onto a substrate, for example, by spin coating.

Related references are further listed below.
Y. Kobayashi, et al., J. Colloid and Interf. Sci., 283 (2005) 601.
C. J. Brinker, G. W. Scherer, SOL-GEL SCIENCE The Physicals and Chemistry of Sol-Gel Processing, Academic Press. Inc. (1990)
Sumio Sakubana, “Zoru-Geru Ho No Kagaku-Kinousei Garasu Oyobi Seramikkusu No Teion Gousei” (Chemistry of Sol-Gel Process—Low-Temperature Synthesis of Functional Glass and Ceramics—), Agune Shofusha (1988)

Thus, the present invention is directed to a metallic fine particle dispersed film in which metallic fine particles densely dispersed within a silicon oxide layer without aggregation of the metallic fine particles.

### BRIEF SUMMARY OF THE INVENTION

The present invention includes a process for producing a metallic fine particle dispersed film comprising: hydrolyzing and polycondensing an organosilane to form a silicon oxide layer with hydroxyl and/or alkoxide groups remaining unremoved on its side chains; bringing the silicon oxide layer into contact with an aqueous acidic tin chloride solution; and then bringing the silicon oxide layer into contact with an aqueous metal chelate solution to disperse metallic fine particles in the silicon oxide layer to obtain a metallic fine particle dispersed film.

According to the process of the present invention, a metallic fine particle dispersed film in which metallic fine particles dispersed densely within a silicon oxide layer can be produced without aggregation of the metallic fine particles.

### BRIEF DESCRIPTION OF THE DRAWINGS

FIGS. 1A and 1B are typical diagrams showing a difference in a polymer structure derived from a difference in a catalyst used.

FIG. 2 is a typical diagram showing a chemisorption reaction of Sn²⁺ within pores formed in a silicon oxide layer.

FIG. 3 is a typical diagram showing reduction of Ag⁺ with chemisorbed Sn²⁺ within pores formed in a silicon oxide layer.

FIG. 4 is a cross-sectional typical diagram of a silicon oxide layer with silver (Ag) nanoparticles densely dispersed therein in an embodiment of the present invention.

FIG. 5 is a diagram showing the results of measurement of a silicon oxide layer by infrared spectroscopy in a working example of the present invention.

FIG. 6 is an absorption spectrum of a silicon oxide layer with silver nanoparticles densely dispersed therein in a working example of the present invention.

### DETAILED DESCRIPTION OF THE INVENTION

As described above, the process for producing a metallic fine particle dispersed film according to the present invention comprises a silicon oxide film, with hydroxyl and/or alkoxide groups remaining unremoved on its side chains, produced by a sol-gel process from an organosilane, specifically, produced by hydrolyzing and polycondensing an organosilane, bringing the silicon oxide layer into contact with an aqueous acidic tin chloride solution; and then bringing the silicon oxide layer into contact with an aqueous metal chelate solution to disperse metallic fine particles in the silicon oxide layer.

The silicon oxide layer as a matrix in which metallic fine particles are to be dispersed is formed by a sol-gel process. In the sol-gel process, in general, an organosilane such as a silicon alkoxide is hydrolyzed or polycondensed to form a silicon oxide layer.

In the present invention, in addition to TEOS (tetraethoxysilane), organosilanes such as TMOS (tetramethoxysilane) and methyltrimethoxysilane can be used as the organosilane. Among them, TEOS is most preferred from the viewpoint of obtaining reproducible stable results. The production process will be described by taking the use of TEOS as an example.

An SiO₂ gel film is first formed on a substrate such as a quartz glass in the presence of an acid catalyst. In this case, a composition comprising tetraethoxysilane, ethanol, HCl, and H₂O at a molar ratio of tetraethoxysilane:ethanol:HCl:H₂O=1:10 to 30:0.05 to 0.2:5 to 15 is particularly preferred as a starting material composition.

Acids such as hydrochloric acid, nitric acid, sulfuric acid, and acetic acid are usable as the acid catalyst. Among them, hydrochloric acid exemplified above in connection with the above composition is most preferred. At the outset, pure water and hydrochloric acid are added to ethanol so as to fall within the above composition range, followed by mixing at room temperature for about 10 to 30 min. Thereafter, TEOS is added, and mixing is carried out at room temperature for about 30 min to 3 hr. The resultant precursor solution is dip or spin coated onto the surface of any desired substrate such as quartz glass.

After coating, preferably, the coated substrate is held at room temperature or ordinary temperature for 24 hr or more to allow partial hydrolysis and polycondensation to proceed. There is a tendency that the film formed in the presence of an acid catalyst has a smaller pore diameter and is more dense as compared with films formed in the presence of a basic catalyst.

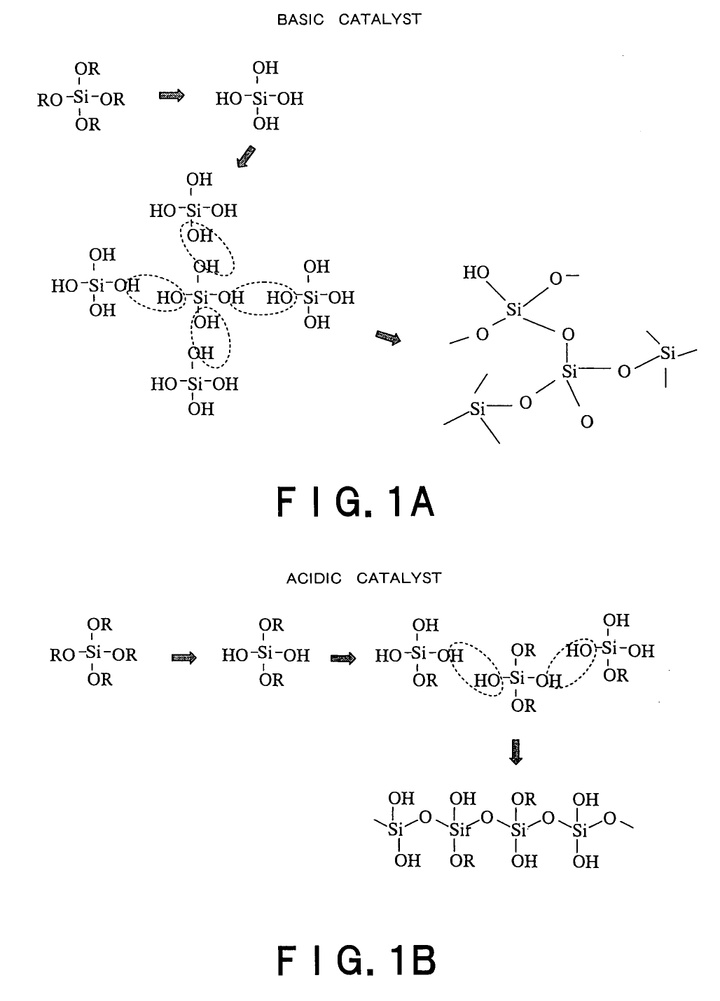

In the present invention, it is important that a number of —OH and/or —OR groups stay on side chains of the silicon compound component as a matrix. In general, when a basic catalyt is used, hydrolysis is less likely to occur. Once a hydrolysis reaction occurs, however, Si(OR)₄ is hydrolyzed to a final stage to produce Si(OH)₄. Specifically, as shown in FIG. 1A, the number of polymerizable sites is four. Accordingly, the polycondensation proceeds in a three-dimensional form, and, thus, a highly crosslinked three-dimensional polymer is likely to be produced. On the other hand, when an acid catalyst is used, as shown in FIG. 1B, polycondensation occurs before the monomer is completely hydrolyzed. Accordingly, the proportion of the occurrence of the crosslinking reaction is low, and, consequently, a linear one-dimensionally developed polymer is likely to be produced. In the present invention, it is estimated that, since the acid catalyst is used, the above structure is likely to be formed.

By virtue of this, linear polymers are stacked on top of each other to form a film. Accordingly, micropores having a size of a few nanometers are likely to be developed. The inside of the micropores is highly hydrophilic because a number of —OH and —OR groups remaining unreacted are present within the micropores. Accordingly, upon contact with an Sn²⁺-containing aqueous solution and an Ag(NH₃)₂⁺-chelate-containing aqueous solution which will be described later, necessary components can rapidly enter the silicon oxide layer. On the other hand, as described above, when a basic catalyst is used, polycondensation proceeds in a three-dimensional form. Therefore, the density of —OH or —OR groups present in a siloxane skeleton within highly crosslinked SiO₂ particles is lower than that within the silicon oxide film according to the present invention. Accordingly, there is no such behavior that, like the above-mentioned reference (Y. Kobayashi, et al., J. Colloid and Interf. Sci., 283 (2005) 601.), a number of silver nanoparticles are deposited within the SiO₂ spheres. Further, since a siloxane bond is developed in a three-dimensional form, when a basic catalyst is used, rounded particles are likely to be produced. When such particulate gels are stacked on top of each other, a structure with relatively large pores attributable to spaces among the particles are likely to be developed.

Thus, according to the process of the present invention, since the deposited silver nanoparticles are present within the pores, unlike the case where the nanoparticles are present on the surface of the pores, the silver nanoparticles within the pores cannot easily be diffused, contributing to more effective suppression of aggregation of the particles.

As described above, in the process according to the present invention, the precursor solution comprising the above starting material composition is dip or spin coated onto a substrate, and, thereafter, preferably, the formed silicon oxide film is held at room temperature for 24 hr or more. As described above, in the present invention, the structure in which a number of —OH or —OR groups are present on the side chains, is actively utilized. To this end, in order to inhibit the polycondensation reaction rate for avoiding the development of a three-dimensional structure, it is important that the step of aging the silicon oxide layer formed on the substrate be carried out at room temperature, that is, under nonheating conditions. On the other hand, in order to form a one-dimensionally developed structure, the hydrolysis and polycondensation reaction as well should be allowed to proceed to some extent. For this reason, preferably, the aging is carried out by drying at room temperature for 24 hr or more. When the above drying step is allowed to proceed, unnecessary alcohol and water can be removed, and, at the same time, the above hydrolysis and polycondensation reaction can be allowed to mildly proceed.

In the present invention, Sn²⁺ is chemisorbed onto the silicon oxide layer by bringing an aqueous acidic tin chloride solution into contact with the silicon oxide layer. The starting material may be tin chloride or a hydrate of tin chloride. Strong acids such as trifluoroacetic acid and hydrochloric acid are added to the aqueous tin chloride solution to enhance the dissociation rate of tin ions. In order to accelerate the dissociation, the use of trifluoroacetic acid as a strong acid is preferred. In this case, the molar ratio of tin chloride to trifluoroacetic acid is preferably in the range of 1:2 to 3. Further, in order to promote the following reaction, the preparation of an aqueous solution which preferably brings the pH value to 3 or less, particularly preferably 2 or less, is preferred.

SnCl₂→Sn²⁺+2Cl⁻

Sn²⁺ is efficiently produced under the above conditions. In this case, particularly preferably, the concentration of Sn²⁺ is brought to 0.15 to 0.35 mmol/L. When the concentration is below the lower limit of the above-defined range, the amount of Sn²⁺ to be chemisorbed is likely to be insufficient. On the other hand, when the concentration is above the upper limit of the above-defined range, an undesired reaction is likely to take place.

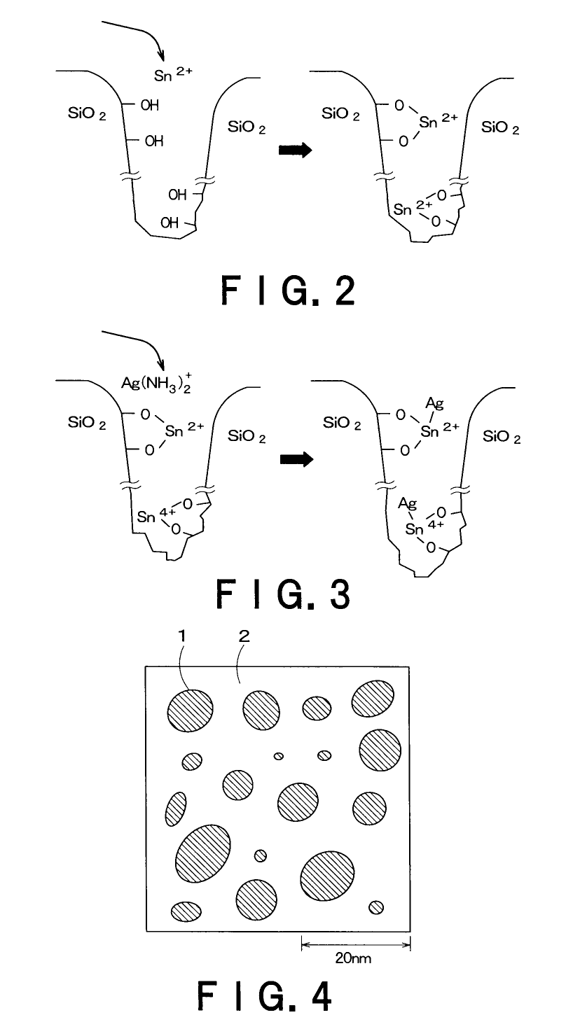

Next, the silicon oxide layer together with the substrate is immersed in the aqueous solution prepared above, whereby the aqueous solution is easily penetrated into the highly hydrophilic micropores within the film and is reacted, for example, with a number of —OH groups present on the wall surface to cause a number of Sn²⁺ to be chemisorbed onto the wall of the pores. The reaction in this case is shown in FIG. 2. The time necessary for the contact (immersion time) varies depending upon the concentration and temperature but should be about 5 min to 3 hr for the satisfactory progress of the reaction. After the chemisorption reaction, the substrate is taken out and is washed with water to fully remove the aqueous tin chloride solution deposited on the surface of the substrate.

In this case, when the prepared aqueous tin chloride solution is allowed to stand for about one day, the aqueous solution is deteriorated (oxidized). Accordingly, when the same step is repeated using the same treating solution repeatedly, preferably, the step is continuously carried out.

Next, the silicon oxide layer treated with the aqueous tin chloride solution is brought into contact with an aqueous metal chelate solution to disperse metallic fine particles densely within the silicon oxide layer.

The metal to be dispersed may be properly selected from gold, silver, platinum, copper, nickel, cobalt, rhodium, palladium, ruthenium, iridium and the like. In a preferred embodiment of the present invention, the aqueous metal chelate solution is an aqueous Ag(NH₃)₂⁺ chelate solution prepared from an aqueous solution containing a silver salt and ammonia. An embodiment in which silver is dispersed and deposited will be described.

An aqueous Ag(NH₃)₂⁺ chelate solution is prepared used in this step. Regarding a preferred composition in this case, silver and ammonia are added to distilled water so that the molar composition ratio of silver to ammonia is 1:2 to 6. When the composition ratio of ammonia is lower than the above-defined range, there is a possibility that the chelae is not produced and, instead, silver colloid is produced. According to the finding of the present inventor, the lower limit of the ammonia composition ratio which can provide a transparent aqueous solution and can prevent silver colloid formation is silver: ammonia=approximately 1:2. However, it should be noted that a composition ratio below the above lower limit may also be adopted so far as the chelae is formed. On the other hand, when ammonia is added at a high concentration of silver to ammonia=1:6 or more, disadvantageously, explosive materials such as AgNH₂ and AgN₃ are likely to be produced as by-products. The silver concentration is preferably regulated in the range of 0.25 to 0.35 mmol/L. When the silver concentration is below the lower limit of the above-defined range, a lot of time is necessary for the reaction. On the other hand, when the silver concentration is above the upper limit of the above-defined range, the reaction is saturated and, thus, the high silver concentration is cost-ineffective.

The silicon oxide layer on which Sn²⁺ has been chemisorbed is immersed in the aqueous Ag(NH₃)₂⁺ chelate solution to bring both the silicon oxide layer and the solution into contact with each other. As with the above step, the aqueous solution is easily penetrated into the highly hydrophilic inside of the pores within the silicon oxide layer to allow the chelated Ag⁺ to be reduced with Sn²⁺ according to the following formula. The reaction in this case is shown as a typical diagram in FIG. 3.

Sn²⁺+2Ag⁺→Sn⁴⁺+2Ag↓

The time necessary for the contact (immersion time) varies depending upon the concentration and temperature but should be about 5 min to 3 hr for the satisfactory progress of the reaction.

It could be confirmed that the above reaction allows a number of silver nanoparticles having a size of not more than 20 nm, particularly about 2 to 8 nm, to be deposited within the silicon oxide layer. This treating solution can be used repeatedly so far as the treating solution can cause a silver deposition reaction takes place. Since, however, the treating solution begins to be deteriorated upon the elapse of about one day, when the same step is repeatedly carried out using the same treating solution, preferably, the treatment is continuously carried out.

After the deposition reaction, the substrate is taken out from the aqueous solution, and the aqueous solution deposited on the surface is removed, followed by drying, whereby a metallic fine particle dispersed film comprising silver fine particles 1, as shown in FIG. 4 (a cross-sectional typical diagram), dispersed densely within a silicon oxide film 2 can be efficiently produced without aggregation of the silver fine particles 1.

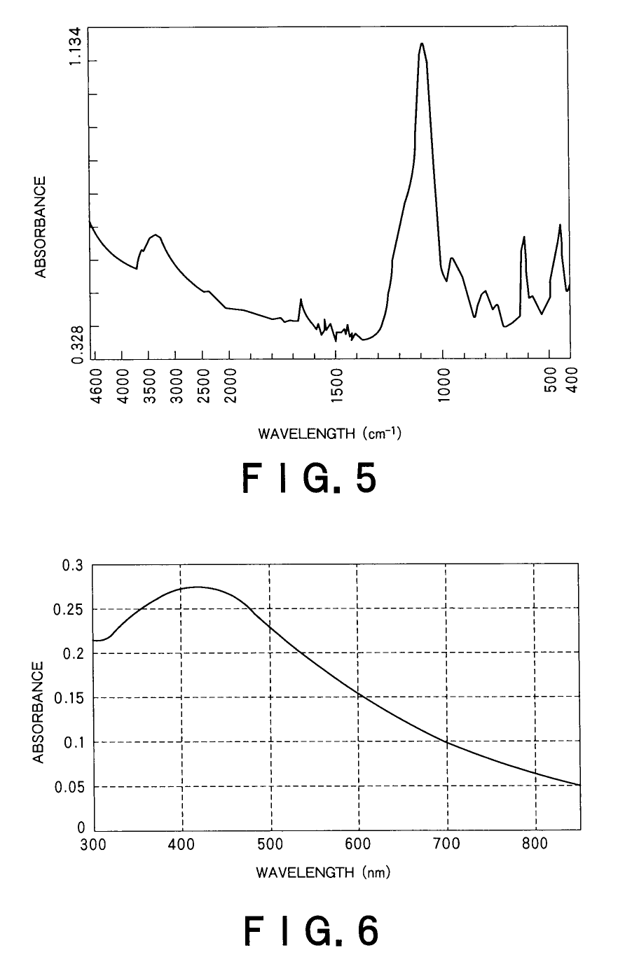

The metallic fine particle dispersed film in the present embodiment produced by carrying out the above two treatments is characterized in that (1) as shown in FIG. 5, peaks attributable to —OH group are observed at 3200 to 3800 cm⁻¹ and 900 to 1000 cm⁻¹ as measured by infrared spectroscopy, and (2) the matrix film contains tin as a reducing agent. Further, the stay of Cl derived from the catalyst is preferred.

The absorption at 3200 to 3800 cm⁻¹ and 900 to 1000 cm⁻¹ is attributable to the vibration of —OH groups derived from silanol group or adsorbed water, as described in the above non-patent documents 3 and 4.

As will be described later with reference to FIG. 6, the silver particle dispersed film produced by the above process has a plasmon absorption peak at 410 nm to 430 nm, and, hence, silver fine particles of a nano-level size are dispersed densely and evenly without the aggregation of the fine particles. Accordingly, the silver particle dispersed film is suitable for use in optical devices, for example, plasmon waveguides and nonlinear optical films.

Further, as described above, in the present invention, all the steps can be carried out under nonheating conditions. Accordingly, heating by a heat source and the application of an ionizing radiation such as UV are unnecessary, and, thus, the present invention is very advantageous from the viewpoint of energy load, that is, for the production process.

### EXAMPLES

The following working examples further illustrate the present invention.

### Example 1

A silicon oxide film was formed by a sol-gel process.

Ethanol (50 ml) was mixed with 9.008 g of pure water and 5 ml of 1 mol/L aqueous hydrochloric acid solution at room temperature for about 30 min. Thereafter, 10.417 g of TEOS was added thereto followed by mixing for 3 hr to prepare a starting material composition (a precursor solution) which has a TEOS concentration corresponding a 1 M/L ethanol solution and has a molar composition ratio of TEOS: H₂O: HCl=1:10:0.1.

### Comparative Example 1

For comparison, a precursor solution using a basic catalyst solution was prepared using pure water (1.8 g) and 4.1 moles of 25% aqueous ammonia were added to 50 ml of ethanol followed by mixing at room temperature for about 30 min. TEOS (4.8 g) was then added to the mixture, and mixing was further carried out for additional about 3 hr to prepare a precursor solution.

A quartz glass substrate having a size of 20 mm×50 mm×1 t was cleaned with water, ethanol, and acetone, was then subjected to UV dry cleaning, and was then applied to an experiment.

Each of the precursor solutions of Example 1 and Comparative example 1 was coated onto the quartz glass substrate by a spinner under conditions of 1000 rpm and 30 sec. Thereafter, the coated substrate was held at room temperature for 24 hr to cause hydrolysis and a polycondensation reaction.

An aqueous tin (Sn) solution for Sn²⁺ chemisorption treatment was prepared. Specifically, 0.05 g of SnCl₂.2H₂O was dissolved in 10 ml of water. Trifluoroacetic acid (0.066 g) was then added to the solution followed by mixing for about one hr. This solution (0.2 ml) was taken out and was added to 19.8 ml of distilled water, and they were mixed together for about 30 min. The molar ratio of tin to trifluoroacetic acid was about 1:2.5.

The silicon oxide film of each of the material of the present invention and the comparative material formed on the quartz glass was immersed in 20 ml of the aqueous tin solution for about one hr. As a result, there was no change in color and the like in the film.

The sample was taken out from the aqueous solution, was washed in 500 ml of pure water, and was then immersed in pure water for about one hr to remove the excess aqueous tin solution.

An aqueous Ag(NH₃)₂⁺ chelate solution was then prepared. Specifically, 0.06 g of silver nitrate was dissolved in 10 ml of pure water, and approximately three drops of 25% aqueous ammonia were added to the solution to prepare a transparent aqueous Ag(NH₃)₂⁺ chelate solution. This aqueous solution (0.2 ml) was taken out, 19.8 ml of distilled water was added thereto, and they were mixed together for about 10 min.

The silicon oxide film of each of Example 1 and Comparative Example 1 subjected to the Sn²⁺ chemisorption treatment was immersed in this aqueous solution for about one hr. As a result, upon the elapse of about 5 min, the color of the film turned brown.

The sample was taken out from the aqueous solution, was washed in 500 ml of pure water, and was then dried at room temperature for 24 hr. After drying, the appearance of the material of the present invention and the comparative material was observed. As a result, it could be clearly confirmed that the sample according to the present invention was strongly colored with brown, indicating that the density of silver (Ag) nanoparticles present in the material was high. That is, as the concentration of the Ag nanoparticles increases, the intensity of color (brown) attributable to absorption increases. On the other hand, for the comparative material, the appearance has a very light brown color. That is, the degree of coloration is very low, indicating that the concentration of the Ag nanoparticles is low.

Further, whether or not the Ag particles prepared in the silicon oxide film according to the present invention has a nanosize was examined based on plasmon absorption behavior. The results of measurement of an absorption spectrum are shown in FIG. 6. It is known that a peak of plasmon absorption of the Ag nanoparticles having a size of about 10 nm present as colloid in an organic solvent is observed at about 420 nm. In this Example, clear plasmon absorption was observed at a wavelength around 410 nm, demonstrating that Ag nanoparticles of the metal rather than an oxide were formed. Further, since the plasmon absorption was observed at 410 nm, it is estimated that the formed Ag nanoparticles if they are in a substantially spherical form had a diameter of not more than 10 nm.

The above absorption spectrum was measured according to the general rule of absorption spectrophotometry specified in JIS K 0115.

### Example 2

A silicon oxide film according to the present invention was formed in the same manner as in Example 1. Specifically, pure water (9.5 g) and 6 ml of a 1 mole/L aqueous nitric acid solution were added to 70 ml of ethanol followed by mixing at room temperature for about 30 min. TEOS (13 g) was then added to the mixture, and the mixture was then stirred for additional about 3 hr to prepare a precursor solution.

A quartz glass substrate having a size of 20×50×1 t was cleaned with water, ethanol, and acetone, was then subjected to UV dry cleaning, and was then applied to an experiment.

The precursor solution according to the present invention was coated onto the quartz glass substrate by a spinner under conditions of 1000 rpm and 30 sec. Thereafter, the coated substrate was held at room temperature for 48 hr to cause hydrolysis and a polycondensation reaction.

An aqueous solution for Sn²⁺ chemisorption treatment was then prepared. Specifically, 0.05 g of SnCl₂.2H₂O was dissolved in 10 ml of water. Trifluoroacetic acid (0.08 g) was then added to the solution followed by mixing for about one hr. This solution (0.2 ml) was taken out and was added to 19.8 ml of distilled water, and they were mixed together for about 30 min.

The film according to the present invention formed on the quartz glass was immersed in 20 ml of the aqueous tin solution for about 2 hr. As a result, there was no change in color and the like in the film.

The sample was taken out from the aqueous solution, was washed in 500 ml of pure water, and was then held in pure water for about one hr to remove the excess aqueous tin solution.

An aqueous Ag(NH₃)₂⁺ chelate solution was then prepared. Specifically, 0.08 g of silver nitrate was dissolved in 10 ml of pure water, and approximately five drops of 25% aqueous ammonia were added to the solution to prepare a transparent aqueous Ag(NH₃)₂⁺ chelate solution. This aqueous solution (0.2 ml) was taken out, 19.8 ml of distilled water was added thereto, and they were mixed together for about 10 min.

The film according to the present invention subjected to the Sn²⁺ chemisorption treatment was immersed in 20 ml of this aqueous solution for about 2 hr. As a result, as with Example1, the color of the film turned brown upon the elapse of about 5 min, demonstrating that the density of silver nanoparticles present in the film was high.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A process for producing a metallic fine particle dispersed film, comprising:
hydrolyzing and polycondensing an organosilane to form a silicon oxide layer with hydroxyl and/or alkoxide groups remaining unremoved on its side chains;
bringing the silicon oxide layer into contact with an aqueous acidic tin chloride solution; and
then bringing the silicon oxide layer into contact with an aqueous metal chelate solution to disperse metallic fine particles in the silicon oxide layer to obtain a metallic fine particle dispersed film.

2. The process according to claim 1, wherein the aqueous metal chelate solution comprises an aqueous Ag(NH₃)₂⁺ chelate solution.

3. The process according to claim 1, wherein the organosilane comprises tetraethoxysilane, and the silicon oxide layer has been produced using a starting material composition comprising tetraethoxysilane, ethanol, HCl, and H₂O at a molar ratio of tetraethoxysilane: ethanol: HCl: H₂O=1:10 to 30:0.05 to 0.2:5 to 15.

4. The process according to claim 1, including the steps of dipping or spin coating a substrate with the starting material composition according to claim 3 to form a corting layer and holding the coating layer at room temperature for 24 hr or more.

5. The process according to claim 1, wherein the aqueous tin chloride solution contains trifluoroacetic acid at a molar ratio of tin chloride:trifluoroacetic acid=1:2 to 3, and has a pH value of 3 or less.

6. The process according to claim 2, wherein the aqueous Ag(NH₃)₂⁺ chelate solution has a silver salt to ammonia molar ratio of 1:2 to 6 and is subtantially transparent.

7. The process according to claim 1, wherein the metallic fine particles are formed of at least one metal selected from the group consisting of gold, platinum, copper, nickel, cobalt, rhodium, palladium, ruthenium, and iridium.

8. The process according to claim 1, which is carried out under nonheating conditions.

9. A metallic fine particle dispersed film comprising a silicon oxide layer containing a plurality of metallic fine particles dispersed therein and tin, the film having peaks at 3200 to 3800 cm⁻¹ and 900 to 1000 cm⁻¹ as measured by infrared spectroscopy.

10. The film according to claim 9, wherein the silicon oxide layer contains chlorine.

11. The film according to claim 9, wherein the metallic fine particles comprises silver, and the film has a plasmon absorption peak at 410 nm to 430 nm.
